(19) United States
(12) Patent Application Publication
(10) Pub. No.: US 2026/0253607 A1
(43) Pub. Date: Aug. 27, 2026

(54) AUDIO FEATURE EXTRACTION FOR DEEPFAKE AUDIO DETECTION

(71) Applicant: The Regents of the University of Michigan, Ann Arbor, MI (US)

(72) Inventors: Hashim Ali, Garden City, MI (US); Hafiz M.A. Malik, West Bloomfield, MI (US)

(21) Appl. No.: 19/548,898

(22) Filed: Feb. 24, 2026

Related U.S. Application Data
(60) Provisional application No. 63/762,625, filed on Feb. 24, 2025.

(51) Int. Cl. G10L 25/69; G10L 15/06; G10L 15/08; G10L 25/30

(52) U.S. Cl. CPC G10L 25/69; G10L 15/063; G10L 15/08; G10L 25/30

(57) ABSTRACT

A method and system for detecting a deepfake audio resource as well as a method and system for training a deepfake detection classifier network. The method for detecting a deepfake audio resource includes: obtaining bonafide audio resource and a deepfake audio resource; generating bonafide audio feature data based on the bonafide audio resource; generating deepfake audio feature data based on the deepfake audio resource; training a machine learning (ML) classifier using the bonafide audio feature data and the deepfake audio feature data; and generating a deepfake audio indicator for a subject audio resource based on an output generated by inputting the subject audio resource into the trained ML classifier.

### GOVERNMENT FUNDING

This invention was made with government support under 1816019 and 2309443 awarded by the National Science Foundation. The government has certain rights in the invention.

### TECHNICAL FIELD

This disclosure relates to classifying audio based on extracting audio features, useful for various purposes including detecting a deepfake, spoofed, or otherwise illegitimate audio sample, clip, file, or other resource, including deepfake detection of human speech.

### BACKGROUND

The proliferation of deepfake technology has introduced significant challenges in the realm of audio authenticity. Deepfake audio, which involves the use of artificial intelligence to generate synthetic audio that mimics human speech, poses a threat to security, privacy, and trust in digital communications. Traditional methods of audio verification and authentication struggle to keep pace with the sophistication of these synthetic audio techniques. Existing approaches often rely on detecting artifacts left by the synthesis process, but these methods are becoming less effective as deepfake technologies evolve to produce more realistic and artifact-free audio.

Current solutions typically involve binary classifiers trained on authentic audio samples. However, these models often fail to generalize well to new, unseen deepfake generation techniques, as they are heavily dependent on specific artifacts present in the training data. This dependency limits their effectiveness in real-world applications where the nature of deepfake audio is continually advancing.

### SUMMARY

According to a first aspect of the invention, there is provided a method of detecting a deepfake audio resource. The method includes: obtaining bonafide audio resource and a deepfake audio resource; generating bonafide audio feature data based on the bonafide audio resource; generating deepfake audio feature data based on the deepfake audio resource; training a machine learning (ML) classifier using the bonafide audio feature data and the deepfake audio feature data; and generating a deepfake audio indicator for a subject audio resource based on an output generated by inputting the subject audio resource into the trained ML classifier.

According to various embodiments, the method of the first aspect of the invention may further include any one of the following features or any technically-feasible combination of some or all of these features:
the bonafide audio feature data and the deepfake audio feature data each includes one or more feature values for each of a plurality of predetermined audio features;
generating the deepfake audio indicator includes generating a binary classification indicator identifying the subject audio resource as legitimate or illegitimate;
generating the deepfake audio indicator includes generating a multi-class indicator identifying a type of deepfake or spoofing technique;
generating the deepfake audio indicator includes generating a confidence score corresponding to a likelihood or anomaly measure associated with the subject audio resource;
generating the deepfake audio indicator includes generating a reason code identifying one or more predetermined audio features whose feature values deviate from a learned bonafide distribution beyond a threshold;
the reason code identifies at least one of: a prosody audio feature, an articulation audio feature, a phonation audio feature, or an embedding-derived feature;
the deepfake audio resource corresponds to the bonafide audio resource whereby the deepfake audio resource is a deepfake version of the bonafide audio resource;
the bonafide audio resource includes speech from a speaker, wherein the deepfake audio resource includes a deepfake version of the speech, and wherein the ML classifier is a speaker-specific ML classifier;
training the ML classifier includes: generating bonafide audio features and deepfake audio features, and wherein the bonafide audio features and the deepfake audio features each includes one or more feature values for each of a plurality of predetermined audio features;
the deepfake audio indicator is generated by: generating audio feature data for the subject audio resource, and generating the deepfake audio indicator as a result of classifying the subject audio resource using the audio feature data as input into the trained ML classifier; and/or
the audio feature data is determined for a plurality of predetermined audio features, and wherein feature values for the plurality of predetermined audio features are included in the audio feature data and are determined using closed-form calculations.

According to a second aspect of the invention, there is provided a method of training a deepfake detection classifier network. The method includes: obtaining a bonafide audio resource; obtaining a deepfake audio resource; determining bonafide audio feature data based on the bonafide audio resource, wherein the bonafide audio feature data includes one or more feature values for each of a plurality of predetermined audio features; determining deepfake audio feature data based on the deepfake audio resource, wherein the deepfake audio feature data includes one or more feature values for each of the plurality of predetermined audio features; performing a first learning operation for a machine learning (ML) classifier using the bonafide audio feature data; and performing a second learning operation for the ML classifier using the deepfake audio resource.

According to various embodiments, the method of the second aspect of the invention may further include any one or more of those features discussed above in connection with the first aspect of the invention and/or any of the following features or any technically-feasible combination of some or all of these features:
the plurality of predetermined audio features includes at least one prosody audio feature, at least one articulation audio feature, and at least one phonation audio feature;
the ML classifier includes multiple ML models;
the multiple ML models include a single-class ML model and a multi-class ML model;
the bonafide audio feature data and the deepfake audio feature data each includes one or more feature values for each of a plurality of predetermined audio features;
the plurality of predetermined audio features includes at least one prosody audio feature, at least one articulation audio feature, and at least one phonation audio feature;
the ML classifier comprises at least one of: (i) a support vector machine; (ii) a logistic regression model; (iii) a random forest classifier; (iv) a gradient-boosted decision tree model; (v) a k-nearest neighbor classifier; (vi) a neural network; (vii) a multilayer perceptron; (viii) a density estimation model; and/or (ix) a hypersphere learning model;
the ML classifier comprises a one-class classifier configured to learn a distribution of bonafide speech and to identify as illegitimate any subject audio resource falling outside a learned boundary; and/or
the learned boundary is defined using at least one of: (i) a one-class support vector machine; (ii) support vector data description (SVDD); (iii) hypersphere learning, density estimation; (iv) Gaussian mixture modeling; and/or (v) kernel-based anomaly detection.

According to a third aspect of the invention, there is provided a method for detecting a deepfake audio resource. The method includes: determining stable audio feature data for a subject audio resource, wherein the stable audio feature data includes feature values for a plurality of predetermined audio features configured to remain invariant under predefined audio transformations; inputting the stable audio feature data into a trained one-class classifier configured to model a distribution of bonafide speech of a subject speaker; and generating a deepfake audio indicator when the stable audio feature data falls outside a learned boundary of the distribution.

According to various embodiments, the method of the third aspect of the invention may further include any one or more of those features discussed above in connection with the first aspect of the invention, the second aspect of the invention, and/or any of the following features or any technically-feasible combination of some or all of these features:
the learned boundary is defined using at least one of: (i) a one-class support vector machine; (ii) support vector data description (SVDD); (iii) hypersphere learning, density estimation; (iv) Gaussian mixture modeling; and/or (v) kernel-based anomaly detection;
the distribution of bonafide speech of the target speaker is determined based only on bonafide speech samples of the target speaker and excludes synthetic or deepfake speech samples during training of the one-class classifier; and/or
the distribution of bonafide speech of the target speaker is defined in a stability-qualified feature space such that bonafide speech samples of the target speaker, including samples captured under varying microphones, codecs, acoustic environments, and processing conditions, are mapped within a compact region bounded by the learned boundary.

According to various embodiments, the method of the first aspect of the invention may further include any one or more of those features discussed above in connection with the second aspect of the invention and the third aspect of the invention.

According to various embodiments, the method of the second aspect of the invention may further include any one or more of those features discussed above in connection with the third aspect of the invention.

According to a fourth aspect of the invention, there is provided a non-transitory, computer-readable medium that stores computer instructions. When the computer instructions are executed by one or more processors, the method of the first aspect of the invention is performed. The fourth aspect of the invention may further include any one or more of the features discussed above in connection with the first aspect of the invention.

According to a fifth aspect of the invention, there is provided a non-transitory, computer-readable medium that stores computer instructions. When the computer instructions are executed by one or more processors, the method of the second aspect of the invention is performed. The fifth aspect of the invention may further include any one or more of the features discussed above in connection with the second aspect of the invention.

According to a sixth aspect of the invention, there is provided a non-transitory, computer-readable medium that stores computer instructions. When the computer instructions are executed by one or more processors, the method of the third aspect of the invention is performed. The sixth aspect of the invention may further include any one or more of the features discussed above in connection with the third aspect of the invention.

### BRIEF DESCRIPTION OF THE DRAWINGS

Preferred exemplary embodiments will hereinafter be described in conjunction with the appended drawings, wherein like designations denote like elements, and wherein:

FIG. 1 is a block diagram depicting a deepfake audio detection environment having a deepfake audio detection system, according to one embodiment;

FIG. 2 is a block diagram depicting a deepfake detection framework that is configured to implement a deepfake detection ML network pipeline, according to one embodiment;

FIG. 3 is a block diagram depicting a portion of the deepfake detection framework of FIG. 2, including a deepfake detection ML network training pipeline, according to one embodiment;

FIG. 4 is a block diagram depicting a portion of the deepfake detection framework of FIG. 2, including a deepfake detection trained ML network pipeline, according to one embodiment;

FIG. 5 is a block diagram depicting examples of audio resource collection pipeline, according to one embodiment;

FIG. 6 is a flowchart depicting a method of detecting a deepfake audio resource, according to one embodiment;

FIG. 7 is a flowchart depicting a method of training a deepfake detection classifier network, according to one embodiment; and

FIG. 8 is a flowchart depicting a method of stable audio feature extraction for a subject audio resource, according to one embodiment.

### DETAILED DESCRIPTION

The system and method described herein enable detecting a deepfake or other spoofed or illegitimate audio resource as being illegitimate, particularly through use of an audio feature extractor that extracts or determines audio feature data for a plurality of audio features, which are then used for determining a deepfake audio indicator. The deepfake audio indicator for a subject audio resource is determined through generating audio feature data for the subject audio resource using the audio feature extractor, and then generating the deepfake audio indicator as a result of executing a deepfake detection machine learning (ML) classifier with the audio feature data for the subject audio resource being used as input into the ML classifier, at least in embodiments.

In the context of the present application, the system and method are directed toward detecting a deepfake, spoofed, or otherwise illegitimate audio sample, clip, file, or other resource having human speech, which is referred to herein as a “deepfake audio resource”; also, the term “deepfake audio indicator” refers to an indicator indicating whether a subject audio resource is a deepfake audio resource or not. Accordingly, in embodiments, the system and method are configured to detect (and provide positive deepfake audio indicators for) deepfake audio resources generated using deepfake technology as well as those that do not use deepfake technology but nonetheless still include audio purporting to be speech of a particular individual. Indeed, according to at least some embodiments, the manner in which the deepfake audio resource is generated is irrelevant to the deepfake detection performed by the system and method, as described herein.

In embodiments, the audio feature extractor is a stable audio feature extractor configured to extract or determine one or more (typically, a plurality of) predetermined audio features, including prosody audio features, articulation audio features, and phonation audio features. As used herein, “stable,” when used in connection with an audio feature extractor, refers to the audio feature extractor being configured for determining audio feature data indicating feature values for each of a plurality of predetermined stable audio features, where a “stable audio feature” is an audio feature that remains intact after various audio generic audio processing transformations, such as, for example, lossy or lossless compression (e.g., MP3 encoding), resampling (e.g., changes to the audio's sampling rate), the addition of noise (e.g., background or white noise), time-scale modifications (e.g., adjustments to playback speed without altering pitch), pitch shifting (e.g., changes to pitch without altering speed), equalization (e.g., modifications to frequency ranges), and laundering attacks (e.g., manipulations such as filtering, clipping, or reverberation).

In embodiments, the stability of the predetermined audio features is defined with respect to invariance or bounded variance under one or more capture, recapture, and pre-processing operations applied to a subject audio resource. Such operations can include, for example and without limitation, playback and re-recording in different acoustic environments, analog-to-digital and digital-to-analog conversions, codec transcoding, bandwidth limitations, channel effects, and other transformations that may be intentionally or unintentionally introduced. The stable audio feature extractor is configured such that, for each predetermined stable audio feature, the corresponding feature value remains substantially preserved, or changes in a predictable and bounded manner, following such operations. In this manner, the extracted audio feature data reflects underlying speech production characteristics rather than superficial signal artifacts introduced by downstream processing.

In embodiments, the audio feature extractor implements one or more stability-oriented extraction procedures that include pre-processing steps configured to normalize or otherwise compensate for transformation effects prior to feature determination. Such pre-processing can include amplitude normalization, noise suppression, band-limiting compensation, temporal alignment, and spectral equalization, among other operations, to enhance invariance of the resulting feature values. According to embodiments, the extractor can generate a vectorized representation comprising a stable feature vector that aggregates the plurality of prosody, articulation, and phonation audio features into a structured feature-level output. In embodiments, the stable feature vector is configured to serve as a classifier-agnostic interface, such that any suitable downstream machine learning classifier can receive the stable feature vector as input for generation of the deepfake audio indicator. Although the stable feature vector may be provided to a single downstream classifier in some embodiments, in other embodiments the stable feature vector may be provided to multiple classifiers whose outputs are optionally combined. Such multi-classifier arrangements are implementation variations, and the stability-oriented feature definitions and extraction procedures remain the primary technical focus.

In at least some embodiments, the audio feature extractor is implemented as a deterministic, closed-form signal processing pipeline that computes the predetermined stable audio features according to defined mathematical formulations. In other embodiments, the audio feature extractor comprises a hybrid architecture in which one or more data-driven models are interposed within the extraction pipeline to adapt, weight, calibrate, or refine the predetermined stable audio features based on training data, while preserving the stability constraints associated with the predetermined feature definitions. According to embodiments, in either the deterministic, closed-form case or the hybrid architecture case, the emphasis of the system remains on the definition and extraction of stability-oriented audio features and the provision of feature-level outputs that are robust to transformation, with the downstream classifier operating on those feature-level outputs to generate the deepfake audio indicator. In certain embodiments, one or more classifiers may operate on the stable feature-level outputs, and multiple classifier outputs may optionally be combined; however, such combination mechanisms are ancillary implementation details and do not alter the stability-oriented feature extraction framework described herein.

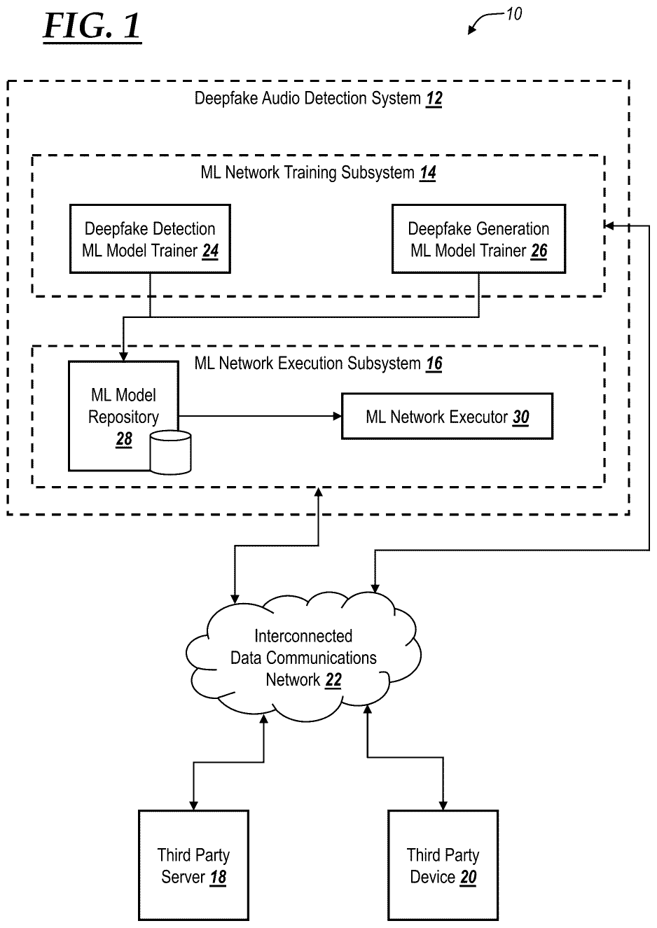

With reference now to FIG. 1, there is shown a deepfake audio detection environment 10 depicting data-communicative relationships amongst the various components of the system 10, which include a deepfake audio detection system 12 having a ML network training subsystem 14 and a ML network execution subsystem 16, a third party server 18, and a third party device 20, which are each communicatively coupled to an interconnected data communications network 22, such as the internet or other non-local interconnected network used for electronic data communications.

The deepfake audio detection system 12 is a computer-implemented system that, according to embodiments, may use any number, arrangement, type, or configuration of computers, other computing devices, etc., as will be appreciated by those skilled in the art. The system 12 is used to perform various functionality, as discussed herein, such as the method(s) and process(es) discussed herein; such functionality is performed by the system 12 through using at least one electronic processor to execute computer instructions, which are stored in memory.

According to embodiments, each of the computer processors or electronic processors discussed herein is an electronic processor that may be implemented as any suitable electronic hardware that is capable of processing computer instructions and may be selected based on the application in which it is to be used. Examples of types of processors that may be used include central processing units (CPUs), graphics processing units (GPUs), field-programmable gate arrays (FPGAs), application specific integrated circuits (ASICs), microprocessors, microcontrollers, etc. According to embodiments, each of the memory or memory devices described herein is or includes non-transitory, computer-readable memory and may be implemented as any suitable type of memory that is capable of storing data or information in a non-volatile manner and in an electronic form so that the stored data or information is consumable by the processor. The memory may be any of a variety of different electronic memory types and may be selected based on the application in which it is to be used. Examples of types of memory that may be used include magnetic or optical disc drives, ROM (read-only memory), solid-state drives (SSDs) (including other solid-state storage such as solid state hybrid drives (SSHDs)), other types of flash memory, hard disk drives (HDDs), non-volatile random access memory (NVRAM), etc. It will be appreciated that any one or more of the computers discussed herein may include other memory, such as volatile RAM that is used by the processor, and/or multiple processors.

The deepfake audio detection system 12 is a system that is used for detecting illegitimate or audio resources (also referred to as “deepfake audio resources,” “deepfake audio,” or “deepfake resources”) and providing an indicator indicating the same. And, more particularly, in at least some embodiments, the deepfake audio detection system 12 is configured for detecting deepfake audio of a set of particular individuals (referred to as the “subject individual(s)” or “subject speaker(s)”), such as one or more politicians, notorious or otherwise famous persons, or other particular persons. As used herein, the term “speaker,” when used in connection with speech, refers to a human being that has spoken, speaks, or is to speak the speech. In such embodiments, the deepfake audio detection system 12 uses the ML network training subsystem 14 for obtaining a trained deepfake detection ML model for each of the subject individual(s) and then uses each respective sole-speaker-specific trained deepfake detection ML model for processing audio from the respective subject individual in order to detect audio deepfakes of that individual. Also, in such embodiments, the ML network training subsystem 14 may be used for generating or obtaining a sole-speaker-specific deepfake generation ML model for each of the subject individual(s) and then using each respective sole-speaker-specific deepfake generation ML model for generating deepfake audio to be used as a part of negative-classification training data when training a ML model to generate a deepfake detection ML model for the respective individual to be used for individualized or sole-speaker-specific deepfake audio detection of new or unseen speaker-specific audio resources.

The ML network training subsystem 14 is used for training ML models using deepfake detection training data in order to generate a deepfake detection ML network having the trained ML models. As discussed above, in at least one embodiment, the deepfake detection ML network includes a first or single-class deepfake detection ML model and a multi-class deepfake detection ML model that are both used together as a part of the deepfake detection ML network. In at least some embodiments, the single-class ML model and the multi-class ML models are both trained for the same, specific individual and are each considered a sole-speaker-specific deepfake detection ML model. The deepfake detection training data is training data used for training ML models for deepfake detection, and includes a plurality of training data entries, each of which includes audio resources.

Although the ML network training subsystem 14 is used for training ML models for deepfake detection, the ML network training subsystem 14 may also be used for training ML models for deepfake generation, which is useful for generating deepfake detection training data used for training ML models, such as the single-class ML model and the multi-class ML model, for deepfake detection. In one embodiment, a deepfake generation ML model is generated for a particular individual as a sole-speaker-specific deepfake generation ML model. In other embodiments, one or more sole-speaker-specific deepfake generation ML models are obtained from a third party ML model provider, which may be provided by the third party server 18, for example.

The ML network training subsystem 14 is implemented by a ML model training computer system that includes at least one computer used for performing training and any other functionality discussed herein as being attributed to or performed by the ML network training subsystem 14. In one embodiment, the training of ML models for deepfake generation is performed on different computer(s) (of the at least one computer) than the computer(s) (of the at least one computer) used for training ML models for deepfake detection; however, in some embodiments, the training of ML models for both deepfake generation and deepfake detection is performed on the same computer(s). Also, in one embodiment, training of deepfake detection models may be performed using the same or different computers, such as where the single-class deepfake detection ML model is trained on a different set of computers (of the at least one computer) than the set of computers (of the at least one computer) used for training the multi-class ML model.

The ML network training subsystem 14 includes a deepfake detection ML model trainer 24 and, in the depicted embodiment, further includes a deepfake generation ML model trainer 26. However, in other embodiments, the deepfake generation ML model trainer 26 is omitted and trained deepfake generation ML models and/or deepfake generation output data (deepfakes generated by trained deepfake generation ML model(s)) are obtained and used for obtaining training data for the deepfake detection ML model training process performed by the deepfake detection ML model trainer 24. The deepfake detection ML model trainer 24 is used for training one or more ML models that are used as a part of a ML network for deepfake detection. In embodiments, the deepfake detection ML network that is to be trained and configured includes two trained ML models, including a single-class ML model and a multi-class ML model. Although a single deepfake detection ML model trainer is shown and described in the present embodiment, it will be appreciated that separate ML trainers may be used for different ML models that are used or to be used as a part of the deepfake detection ML network. For example, in one embodiment, the deepfake detection ML model trainer 24 includes a first trainer configured for training the single-class ML model and a second trainer configured for training the multi-class ML model. These trainers, which correspond to software modules implemented by at least one processor executing computer instructions, may share resources, be performed by the same or different computers, or may otherwise be configured in a number of different ways, depending on the application and environment in which they are used and implemented.

The ML network execution subsystem 16 is used for deepfake detection and referred to as a deepfake detection subsystem, and performs deepfake detection through executing one or more trained deepfake detection ML models using an audio resource as input thereinto. Such audio resources that are considered for deepfake detection are each referred to here as a “subject audio resource.” For each subject audio resource, the deepfake detection ML network generates a deepfake audio indicator that indicates whether the subject audio resource is a deepfake or not; that is, it indicates whether the subject audio resource is illegitimate or not. Furthermore, at least in some embodiments, two separate deepfake detection ML models are each used to receive the subject audio resource and generate a deepfake detection result, and the two deepfake detection results are then combined or otherwise used together to form, generate, or otherwise obtain the deepfake audio indicator for the subject audio resource.

The ML network execution subsystem 16 includes an ML model repository 28 and an ML network executor 30. The ML model repository 28 stores the trained deepfake detection ML models and permits access by the ML model executor 30 to the deepfake detection ML models stored in the repository 28. The ML model repository 28 is implemented using one or more non-transitory, computer-readable memory devices, and may be implemented using memory devices local to or a part of the hardware components used for the ML network execution subsystem 16 and/or may be stored remotely, such as on a virtual private network accessible via the interconnected data communications network 22. The ML model executor 30 is used for executing one or more trained deepfake detection ML models, and this may include performing inference using the trained deepfake detection ML model(s) on an input or subject audio resource. As shown in FIG. 1, ML models trained by the deepfake detection ML model trainer 24 are provided to the ML model repository 28 and stored therein and then used by the ML network execution subsystem 16 for execution in order for deepfake detection. Also, as shown in FIG. 1, in at least some embodiments, deepfake generation ML models, such as those trained by the deepfake generation ML model trainer 26, are stored in the ML model repository 28. In embodiments, the ML model repository 28 includes multiple different tables, directories, schemas, or partitions for storing different types of models, and may be implemented using any of a number of different model repository or storage platforms.

In embodiments, the ML network execution subsystem 16 is configured to support streaming or online deepfake detection. In such embodiments, the feature extractor operates incrementally on an incoming audio stream, performing feature extraction over rolling or sliding time windows. A provisional deepfake audio indicator may be generated for each window and updated at defined temporal intervals (e.g., every N seconds or after accumulation of a defined number of frames). The ML model executor 30 may aggregate window-level indicators to produce a continuously updated confidence measure or binary decision for the evolving audio stream. According to embodiments, this streaming configuration enables near real-time detection during live calls, conferencing sessions, broadcast streams, or other real-time communication scenarios.

Further, in embodiments, the ML network execution subsystem 16 supports deployment across heterogeneous compute environments, including edge devices and server-based infrastructures. For example, a reduced-complexity version of the feature extractor may be implemented on a client device, mobile device, embedded system, or telephony endpoint to perform low-compute, stability-oriented feature extraction and preliminary one-class boundary evaluation. Extracted stable feature vectors or intermediate embedding representations may optionally be transmitted to a remote server for secondary analysis, confirmation, or ensemble evaluation using more computationally intensive models stored in the ML model repository 28. According to embodiments, this tiered architecture enables low-latency local detection while preserving the ability to perform higher-fidelity server-side validation when desired.

Also, in embodiments, the ML network execution subsystem 16 supports batch screening of stored or archived media content. Stable feature vectors corresponding to a plurality of audio resources within a media library may be precomputed and stored in association with those resources. The system may perform large-scale analysis by conducting similarity comparisons, density estimation, or approximate nearest neighbor searches within the stability-qualified feature space to identify anomalous or suspicious audio items. Such batch processing embodiments enable efficient screening of large media repositories, social media uploads, call archives, or evidentiary datasets without requiring full reprocessing of raw audio for each query.

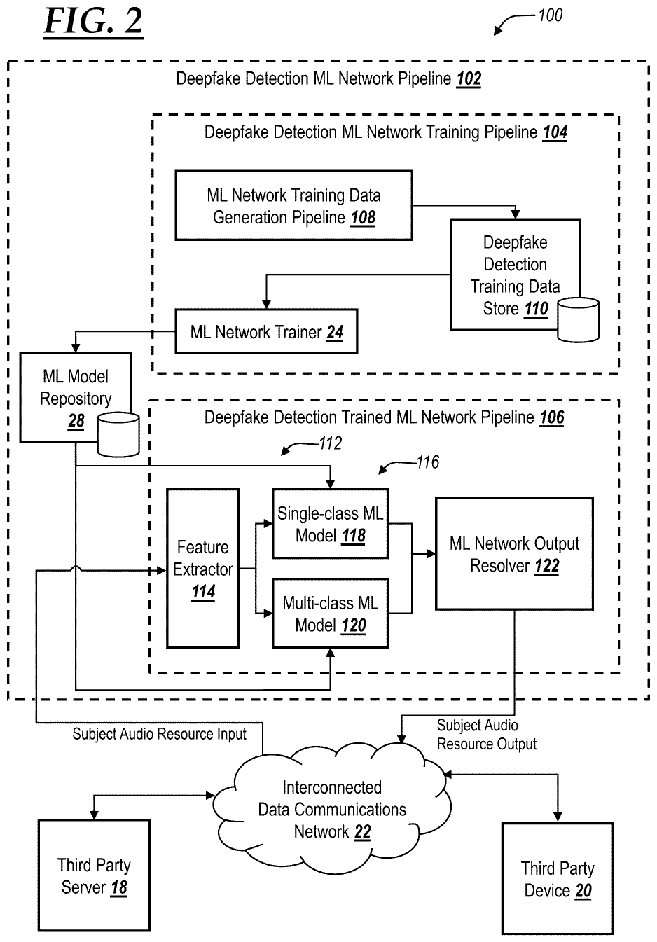

With reference to FIGS. 2-4, there is shown a deepfake detection framework 100 implementing a deepfake detection ML network pipeline 102 for deepfake detection for a particular individual whereby a deepfake detection ML network generates a deepfake audio indicator for the particular individual based on a subject audio resource for the particular individual. The deepfake detection ML network pipeline 102 (or “deepfake detection pipeline” for short) includes a deepfake detection ML network training pipeline 104 for generating a trained ML network and a deepfake detection trained ML network pipeline 106 for executing the trained ML network in order to determine whether a subject audio resource is a deepfake or otherwise illegitimate or not, and may include classifying a type of deepfake, such as through use of a multi-class deepfake detection ML model. The deepfake detection framework 100 and its pipeline 102 are implemented using the deepfake detection system 12.

In general, the deepfake detection ML network training pipeline 104 is used for training a ML network for deepfake detection in order to obtain a trained ML network. The trained ML network is then stored in the ML model repository 28, thereby permitting the deepfake detection trained ML network pipeline 106 access to the trained ML network. The deepfake detection trained ML network pipeline 106 is used for determining a deepfake audio indicator, which is an indicator indicating that the subject audio resource is a deepfake or otherwise illegitimate or not. The deepfake audio indicator also may indicate a type of spoofing or deepfake for the subject audio resource, such as, for example, through use of a multi-class deepfake detection ML model.

The deepfake detection ML network training pipeline 104 includes a ML network training data generation pipeline 108 for generating deepfake training data, a deepfake training data store 110 for storing the deepfake training data, and the ML network trainer 24 for training a ML model in order to generate a deepfake detection trained ML network, which is then output by the deepfake detection ML network training pipeline 104 and stored in the ML model repository 28.

The deepfake detection trained ML network pipeline 106 is used for executing the deepfake detection ML network that was trained by the deepfake detection ML network training pipeline 104 for an inputted subject audio resource, which is shown as being received as a subject audio resource input from the interconnected data communications network 22. The subject audio resource input may be sent or provided by a user using the third party device 20 or automatically by the third party server 18, for example. In some embodiments, the user indicates a uniform resource locator (URL) at which the subject audio resource may be accessed.

The deepfake detection trained ML network pipeline 106 includes a deepfake detection trained ML network 112 and, in FIG. 2, this trained ML network 112 includes an audio feature extractor 114 used for extracting features and a deepfake detection classifier network 116 comprised of a single-class ML model 118 and a multi-class ML model 120. The deepfake detection classifier network 116 is also referred to as a “deepfake detection classifier” and is a type or example of an ML classifier. The single-class ML model generates a binary indicator indicating, with a first value (e.g., 0, False), that the subject audio resource is a deepfake or otherwise illegitimate and indicating, with a second value (e.g., 1, True), that the subject audio resource is not a deepfake or is otherwise legitimate. In the case of executing multiple ML models as a part of the deepfake detection classifier network 116, the respective outputs of the ML models (e.g., a single-class output for the single-class ML model 118 and a multi-class output for the multi-class ML model 120) are then combined or otherwise each used for determining a subject audio resource output, which indicates whether the subject audio resource is not a deepfake or is otherwise legitimate and, in embodiments, may indicate further information regarding the subject audio resource, such as a type or source of the subject audio resource, for example, when the subject resource is determined to be a deepfake. The subject audio resource output is shown as being provided to the interconnected data network 22, which may be used for ultimately providing the subject audio resource output to the third party server 18 and/or the third party device 20, such as for storage in a third party database or viewing by a user on an electronic display screen of the third party device 20, for example.

According to one embodiment, the single-class ML model 118 is a one-class support vector machine (SVM) that is trained on the positive class in the training data or positive training data, which includes legitimate or bonafide audio samples or resources and not deepfake audio resources. In other embodiments, the single-class ML model 118 may be trained on deepfake audio resources (or negative training data) as well.

According to one embodiment, the multi-class ML model 120 is a Gaussian mixture model (GMM) that is trained on both positive and negative training data. The GMM is useful when the collected audio resources for the subject speaker contain many different types of audio deepfakes. Alas, due to the infeasibility or impracticality of acquiring such types of deepfakes, the one-class or single-class ML model 118 provides useful robustness and/or corroboration for determinations made by the multi-class ML model 120. Accordingly, together, the single-class ML model 118 and the multi-class ML model 120 are used together as part of the deepfake detection classifier network 116 to classify unseen audio samples or resources as either being bonafide or illegitimate.

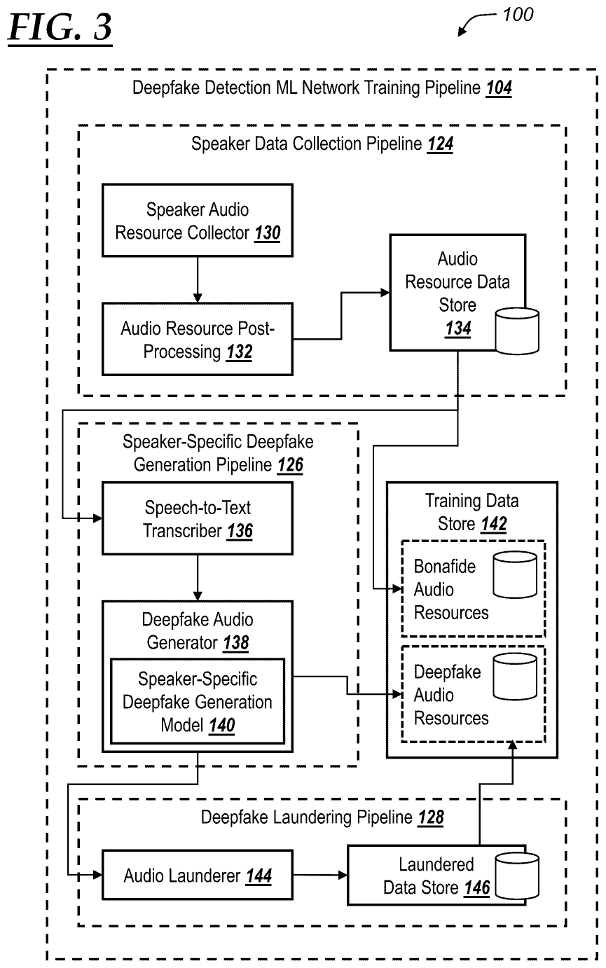

With specific reference now to FIG. 3, there is shown the ML network training data generation pipeline 104, which includes a speaker data collection pipeline 124 for obtaining legitimate (“bonafide”) audio resources for a subject speaker, a speaker-specific deepfake generation pipeline 126 for generating deepfake audio versions of the bonafide audio resources, and a deepfake laundering pipeline 128 for modifying the deepfake audio versions using one or more deepfake laundering techniques in order to generate laundered deepfake audio data. Accordingly, at least in one embodiment, the ML network training data generation pipeline 104 generates training data entries including single-class ML model training data for training a single-class ML model and multi-class ML model training data for training a multi-class ML model. The singe-class ML model training data may include a plurality of single-class or binary training data entries, each of which includes a subject audio resource as input and a binary deepfake indicator indicating whether or not the subject audio resource is a deepfake or a bonafide resource. The multi-class ML model training data may include a plurality of multi-class training data entries, each of which includes a subject audio resource as input and an audio classification indicator, such as a deepfake classification indicator indicating a type of deepfake, for the subject audio resource.

The speaker data collection pipeline 124 is used for collecting real audio recordings of the subject speaker, such as a public figure (e.g., President of the United States of America), and storing the recordings as bonafide audio resources, which may then be used for training. The speaker data collection pipeline 124 includes a speaker audio resource collector 130 for obtaining real audio recordings of the subject speaker, a post-processor 132 for performing standardization or other various desired processing prior to storage in order to generate prepared audio resource data, and an audio resource data store 134 for storing the prepared audio resource data. In embodiments, the speaker audio resource collector 130 obtains the bonafide audio resources automatically, such as, for example, through automatically searching YouTube™ for URLs of the speaker in which the speaker speaks, downloading the resulting videos using the URLs, and then extracting audio from the videos to obtain extracted audio. For example, the videos may be downloaded using Python™ script utilizing the Python™ library named “yt_dl” and, after downloading a video file, the audio is extracted from the downloaded video file into a WAV format with a sampling rate of 16 KHz, for example. The extracted audio may be diarized using speaker diarization technique(s) to determine which a speaker for each portion of speech within the extracted audio. Those portions in which the speaker is the subject speaker are then used as legitimate or bonafide audio resources for the subject speaker. Prior to being stored in the audio resource data store 134, the audio resources may be processed by the post-processor 132 in order to prepare the audio resource data for storage and/or for one or more intended uses, such as for training.

The speaker-specific deepfake generation pipeline 126 is used for generating deepfake audio versions of the bonafide audio resources stored in the audio resource data store 134. The speaker-specific deepfake generation pipeline 126 includes a speech-to-text transcriber 136 for transcribing the bonafide audio resources into a textual version represented as audio transcription data, a deepfake audio generator 138 that uses the audio transcription data as input into a speaker-specific deepfake generation model 140 for the subject speaker in order to generate deepfake audio versions of the transcribed text, and a training data store 142 for storing the generated deepfake audio versions and each's corresponding bonafide audio resource for the subject speaker.

The speaker-specific deepfake generation model 140 is a ML model for generating deepfake audio for a transcription input, such as text representing speech. In one embodiment, the speaker-specific deepfake generation model 140 is generated training or otherwise adapting an audio deepfake generation base model, such as those provided by ElevenLabs™ or StyleTTS/StyleTTS2™, to the subject speaker through using the transcription inputs and corresponding audio resources. In other embodiments, the speaker-specific deepfake generation model 140 is trained or otherwise developed by a third party and obtained therefrom, such as from the third party server 18 or the third party device 20 via the interconnected data communications network 22. For example, ParrotAI™ does not presently allow training f new models, but has already trained deepfake audio generation models for many famous figures. In embodiments, the generated deepfake audio resources and corresponding bonafide audio resources are used not only for classifier training, but also for training or calibrating speaker-specific embedding models configured to unify bonafide speech into compact stable representations while separating synthetic speech in an embedding space.

In addition to generating speaker-specific deepfake audio resources for training and evaluation, embodiments of the present system further contemplate speaker-specific detection models that operate using stability-qualified acoustic features and/or learned speaker embeddings. More particularly, in certain embodiments, a representation learning component is configured to generate a compact embedding representation of bonafide speech for a subject (or target) speaker, such that multiple bonafide utterances from the subject speaker are mapped to a unified region in an embedding space while synthetic or spoofed speech purportedly corresponding to the same speaker is mapped to a separable region of that embedding space. In this manner, the detection framework extends beyond classification based solely on handcrafted acoustic features and includes embedding-based discrimination informed by stability-aware feature extraction.

In embodiments, an embedding learning model is trained or configured to learn a speaker-specific representation space in which bonafide speech samples associated with a subject speaker are clustered or otherwise compactly represented, while deepfake or synthetic speech samples are separated by a measurable margin. Such embedding learning may be implemented using metric learning objectives, contrastive learning objectives, triplet-loss formulations, center-loss formulations, or other representation learning techniques that encourage intra-speaker compactness and inter-class separability. The embedding learning model may operate on the stable feature vector produced by the feature extractor 114, on supplemental embedding-based features as described herein, or directly on acoustic representations subject to stability constraints.

In embodiments, stability criteria are incorporated into the embedding learning process to ensure that embeddings derived from bonafide speech of the subject speaker remain consistent under predefined transformation families, including compression, resampling, replay, noise addition, and laundering manipulations. For example, training objectives may include stability regularization terms that penalize embedding drift between original and transformed versions of the same bonafide utterance. As a result, the learned embedding space is structured not only to distinguish bonafide and synthetic speech, but also to preserve invariance of bonafide speech representations under channel and processing variability.

The deepfake laundering pipeline 128 is used for modifying deepfake audio in order to generate laundered versions of the deepfake audio that include audio laundering attack artifacts, which is any artifact indicative or suggestive of a laundering attack for an audio resource. The audio laundering attack artifacts are introduced by an audio launderer 144, and the resulting laundered deepfake audio may be stored in a data store (referred to as the laundered data store) 146 and/or in the training data store 142 for use as negative training data.

The bonafide and deepfake audio resources may be divided into train and test partitions with a partition train: test ratio of, for example, 70:30. This partitioned data is then passed to the feature extractor 114 where, for example, three types of features are extracted, namely prosody, articulation, and phonation, as discussed more below.

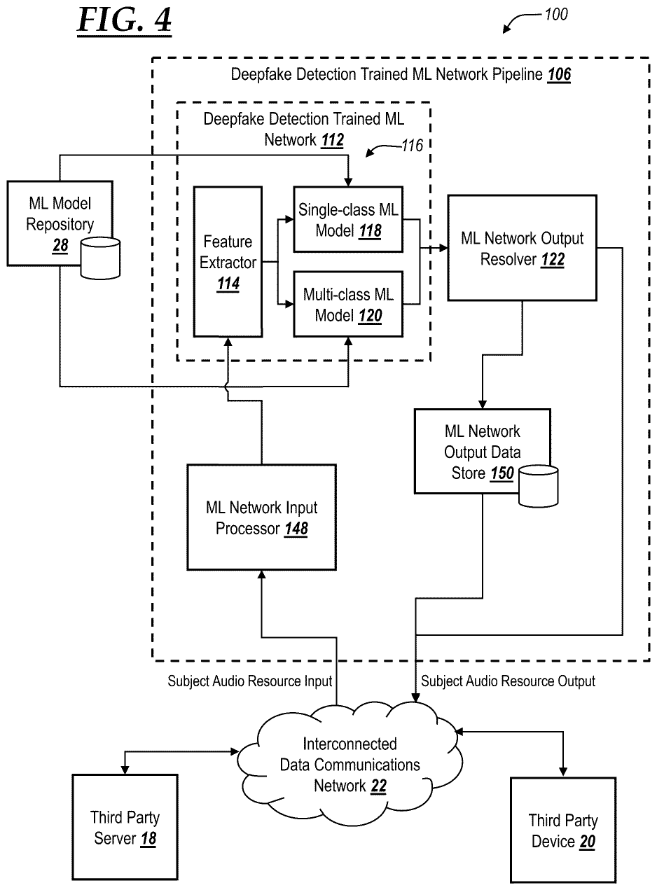

With specific reference now to FIG. 4, the deepfake detection trained ML network pipeline 106 is shown as including an ML network input processor 148 for receiving a subject audio resource input and preparing the subject audio resource indicated thereby for input into the trained ML network 112, the feature extractor 114 for generating audio feature data for the subject audio resource, the deepfake detection classifier network 116 (including its single-class ML model 118 and multi-class ML model 120), the ML network output resolver 122 for determining a deepfake audio indicator, and a ML network output data store 150 for storing the deepfake audio indicator. The deepfake audio indicator may be provided as the subject audio resource output to a third party, and this output may be provided directly from the ML network output resolver 122 or from the ML network output data store 150.

The feature extractor 114 is shown as being separate from each of the single-class ML model 118 and the multi-class ML model 120. More particularly, the feature extractor 114 obtains a subject audio resource as input and in a form as prepared by the ML network input processor 148, and then uses the subject audio resource to generate audio feature data that is then input into each of the single-class ML model 118 and the multi-class ML model 120. The feature extractor 114 is used for extracting audio features from the subject audio resource and, in embodiments, the extracted audio features may be latent features or may be features corresponding to known speech or audio attributes, such as prosody, articulation, and phonation, for example.

According to one embodiment, the feature extractor 114 is used to extract one or more prosody features, one or more articulation features, and one or more phonation features from the subject audio resource, and these extracted audio features are represented as audio feature data. In embodiments, the extracted audio features correspond to predetermined stable audio features whose robustness to defined transformation sets is quantified using one or more stability metrics, as discussed further below. In embodiments, the extracted audio features may include deterministic signal-derived features, representation-agnostic statistical descriptors, and stability-qualified learned embedding features, each evaluated according to defined stability criteria prior to inclusion in the stable feature vector.

Prosody audio features are based on fundamental frequency (referred to “fundamental frequency-based features”), energy (referred to “energy-based features”), and duration (referred to “duration-based features”). Fundamental frequency (F0) based features include the following features: F0-contour Avg., Std., Max., Min., Skewness, Kurtosis (Prosody Features 1-6); tilt of a linear estimation of F0 for each voiced segment Avg., Std., Max., Min., Skewness, Kurtosis (Prosody Features 7-12); mean-squared-error (MSE) of a linear estimation of F0 for each voiced segment Avg., Std., Max., Min., Skewness, Kurtosis (Prosody Features 13-18); F0 on the first voiced segment Avg., Std., Max., Min., Skewness, Kurtosis (Prosody Features 19-24); and F0 on the last voiced segment Avg., Std., Max., Min., Skewness, Kurtosis (Prosody Features 25-30). These first thirty (30) audio features are each an example of a fundamental frequency-based prosody audio feature.

In regards to prosody audio features, energy-based features may include one or more of the following features: energy-contour for voiced segments Avg., Std., Skewness, Kurtosis (Prosody Features 31-34); tilt of a linear estimation of energy contour for V segments Avg., Std., Skewness, Kurtosis (Prosody Features 35-38); MSE of a linear estimation of energy contour for V segment Avg., Std., Skewness, Kurtosis (Prosody Features 39-42); energy on the first voiced segment Avg., Std., Max., Min., Skewness, Kurtosis (Prosody Features 43-48); energy on the last voiced segment Avg., Std., Max., Min., Skewness, Kurtosis (Prosody Features 49-54); energy-contour for unvoiced segments Avg., Std., Skewness, Kurtosis (Prosody Features 55-58); tilt of linear estimation of energy contour for U segments Avg., Std., Skewness Kurtosis (Prosody Features 59-62); MSE of a linear estimation of energy contour for U segments Avg., Std., Skewness, Kurtosis (Prosody Features 63-66); energy on the first unvoiced segment Avg., Std., Max., Min., Skewness, Kurtosis (Prosody Features 67-72); and energy on the last unvoiced segment Avg., Std., Max., Min., Skewness, Kurtosis (Prosody Features 73-78). These forty eight (48) audio features are each an example of an energy-based based prosody audio feature.

In regards to prosody audio features, duration-based features may include one or more of the following features: voiced rate Number of voiced segments per second (Prosody Feature 79); duration of voiced Avg., Std., Max., Min., Skewness, Kurtosis (Prosody Features 80-85); duration of unvoiced Avg., Std., Max., Min., Skewness, Kurtosis (Prosody Features 86-91); duration of pauses Avg., Std., Max., Min., Skewness, Kurtosis (Prosody Features 92-97); and duration ratios pause/(voiced+unvoiced), pause/unvoiced, unvoiced/(voiced+unvoiced), voiced/(voiced+unvoiced), voiced/pause, unvoiced/pause (Prosody Features 98-103). These twenty-five (25) audio features are each an example of a duration-based prosody audio feature.

Articulation audio features refer to those features pertaining to the shaping of sounds into words, such as through forming consonant and vowel sounds. Articulation audio features may include: Bark band energies in onset transitions (Articulation Features 1-22); Mel frequency cepstral coefficients (MFCCs) in onset transitions (Articulation Features 23-34); first derivative of the MFCCs in onset transitions (Articulation Features 35-46); Second derivative of the MFCCs in onset transitions (Articulation Features 47-58); Bark band energies in offset transitions (Articulation Features 59-80); MFCCs in offset transitions (Articulation Features 81-92); first derivative of the MFCCs in offset transitions (Articulation Features 93-104); second derivative of the MFCCs in offset transitions (Articulation Features 105-116); the first formant frequency (Articulation Features 117); first Derivative of the first formant frequency (Articulation Feature 118); second derivative of the first formant frequency (119); second formant Frequency (Articulation Feature 120); first derivative of the second formant frequency (Articulation Feature 121); and second derivative of the second formant frequency (Articulation Feature 122). In embodiments, each of these exemplary articulation audio features ay be used and formed as a static feature vector with four-hundred eighty-eight (Articulation Feature 488) features, including one-hundred twenty-two (122) descriptors x four (4) functions: mean (“Avg.”), standard deviation (“Std.”), skewness, and kurtosis.

Phonation audio features refer to those features that are based on sustained vowels and continuous speech utterances. According to one embodiment, seven (7) descriptors are computed over the voice segments, including: first derivative of the fundamental frequency; second derivative of the fundamental frequency; jitter; shimmer; amplitude perturbation quotient; pitch perturbation quotient; and logarithmic energy. In one embodiment, a static feature vector is formed with 28 phonation audio features and contains seven (7) descriptors x four (4) functionals (Avg., Std., skewness, kurtosis).

In embodiments, the stability of each extracted audio feature is quantified using a measurable stability score determined with respect to one or more predefined audio transformation sets. For a given audio feature, a stability score may be computed as a statistical measure of variation between a baseline feature value derived from an original audio resource and corresponding feature values derived from one or more transformed versions of that audio resource. In exemplary embodiments, the stability score comprises an expected absolute deviation, normalized deviation, variance, or other distance metric computed over a distribution of transformations. In other embodiments, the stability score comprises a correlation measure, such as Pearson correlation, Spearman correlation, or cosine similarity, between feature sequences computed before and after transformation. A feature may be designated as “stable” if its stability score satisfies a predetermined criterion, such as remaining within a bounded deviation range or exceeding a minimum correlation threshold.

The predefined transformation sets used to compute stability scores may include one or more families of audio transformations representative of real-world capture, recapture, distribution, and laundering conditions. Such transformation families may include, without limitation: codec transformations (e.g., MP3, AAC, Opus, or other codec families) across defined bitrate ranges; resampling operations across specified sampling rate ratios; additive noise within predefined signal-to-noise ratio (SNR) bands; reverberation characterized by defined reverberation time (RT60) ranges; amplitude clipping at defined thresholds; dynamic range compression with specified attack, release, and ratio parameters; and device, microphone, or channel impulse responses representative of telephony, VoIP, mobile capture, or social media platform re-encoding. In embodiments, stability scores may be computed per feature and per transformation family, thereby enabling characterization of feature robustness across heterogeneous deployment conditions.

In embodiments, the feature extractor 114 or an associated configuration module performs feature selection based on the computed stability scores. More particularly, a subset of the prosody, articulation, and phonation audio features may be selected for inclusion in the stable feature vector based on the stability score of each feature exceeding a predefined stability threshold. The stability threshold may be defined globally or per transformation family and may correspond to a target deployment environment, such as mobile device capture, telephony or VoIP transmission, conferencing systems, or social media re-upload scenarios. In this manner, the stable feature vector may be tailored to include only those features demonstrating sufficient robustness for the intended operational environment, thereby improving reliability of downstream deepfake detection.

In further embodiments, the system performs per-environment calibration in which the stability threshold and/or selected subset of features are dynamically adapted based on observed or inferred channel characteristics associated with a subject audio resource. For example, metadata or signal analysis may indicate codec type, estimated bitrate, estimated SNR, estimated reverberation level, dynamic range compression characteristics, or device/channel impulse response properties. Based on such observed characteristics, the system may select a corresponding transformation profile and adjust the stability threshold or feature subset accordingly. Thus, the composition of the stable feature vector may be adaptively determined to maintain invariance under the specific capture or transmission conditions associated with the subject audio resource.

In further embodiments, the feature extractor 114 is configured to compute additional representation-agnostic statistical descriptors derived from short-term spectral or cepstral features over defined speech segments. For example, distributions of short-term spectral magnitudes, spectral centroid, spectral bandwidth, spectral flux, or cepstral coefficients may be aggregated over voiced segments, unvoiced segments, or entire utterances to produce higher-order statistical summaries. Such summaries may include histogram-based descriptors, percentile measures, entropy measures, complexity measures, or other distributional statistics. Long-term average spectrum (LTAS) descriptors and related long-horizon spectral envelope characteristics may also be computed. In embodiments, these representation-agnostic statistics are evaluated according to the stability criteria described above and included in the stable feature vector when their corresponding stability scores satisfy predetermined thresholds.

In additional embodiments, the feature extractor 114 incorporates one or more pretrained self-supervised speech representation models configured to generate embedding representations from the subject audio resource. Such models may include, for example, transformer-based or convolutional speech encoders trained using self-supervised objectives on large-scale speech corpora. In this embodiment, embeddings generated by the encoder are treated as supplemental candidate features and are processed to generate embedding-based feature data for potential inclusion in the stable feature vector. The encoder may be implemented in a frozen configuration, fine-tuned using labeled deepfake detection data, or post-trained for spoof detection tasks, depending on the deployment scenario.

In embodiments, stability constraints are applied to embedding-based features in a manner analogous to that described for closed-form prosody, articulation, phonation, and statistical features. More particularly, embedding layers, embedding dimensions, pooled representations, or summary statistics derived from embeddings (e.g., mean-pooled vectors, variance descriptors, or temporal aggregation outputs) are evaluated under predefined transformation families including compression, resampling, replay, and laundering operations. Only those embedding-derived components that satisfy defined stability criteria are designated as stable embedding features and incorporated into the stable feature vector supplied to the downstream classifier.

In further embodiments, a stability-aware embedding selection procedure is implemented to quantify robustness of embedding components under one or more transformation families. For example, embedding stability may be measured using metrics including embedding variance across transformed instances, preservation of cosine similarity between baseline and transformed embeddings, correlation measures, or distributional shift metrics computed across embedding dimensions. A stability score may be computed per embedding layer, per embedding dimension, or per aggregated embedding statistic. Embedding components whose stability scores exceed a deployment-specific stability threshold are selected for inclusion in the stable feature vector, while components failing to satisfy the threshold are excluded. The deployment-specific threshold may be defined globally or calibrated per target environment, thereby ensuring that learned embedding features incorporated into the system satisfy the same stability-oriented design principles as the deterministic audio features described herein.

The above-discussed audio features for the subject audio resource are then used as input into the deepfake detection classifier network 116, which is used to generate a deepfake audio indicator for the subject audio resource. The deepfake audio indicator may then be communicated to a user or other computer system, or stored in memory for later use. In embodiments, the deepfake audio indicator indicates a speech-to-audio-capture type for the subject audio resource, indicating audio processing and/or recapturing performed on the subject audio resource prior to deepfake detection for the subject audio resource. In embodiments, the speech-to-audio-capture type indicates one or more tools or process techniques performed. As used herein, the term “speech-to-audio-capture,” when used in connection with a subject audio resource, refers to a data capture and processing pipeline for capturing spoken words or utterances as speech from a user and processing the captured speech so as to generate audio data representing the speech from the user. Accordingly, a speech-to-audio-capture type is a type of processing performed prior to obtaining the subject audio resource for deepfake detection such that the version of the subject audio resource input for deepfake detection is a version that has been through the processing.

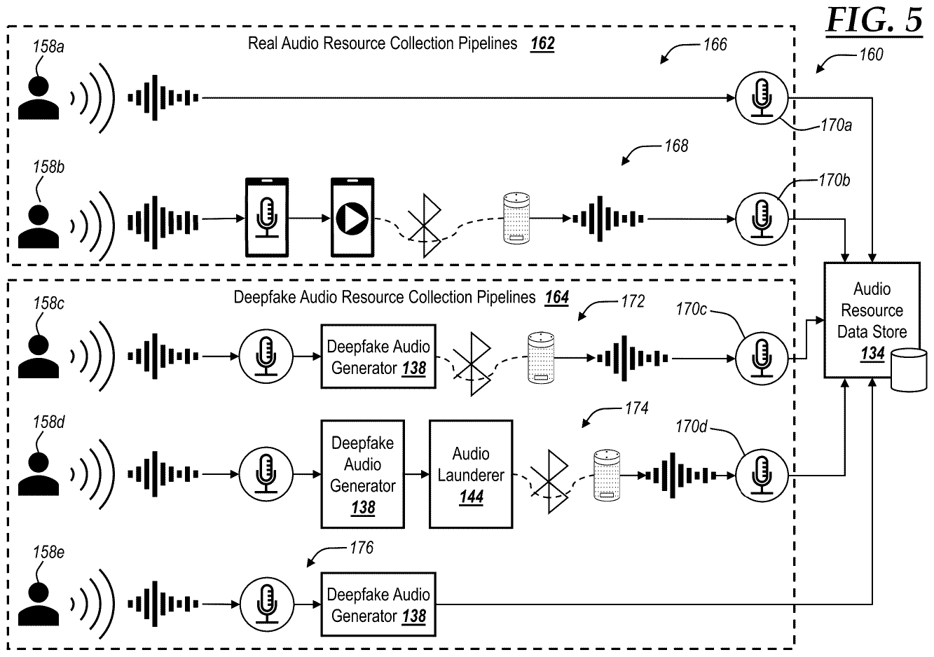

With reference to FIG. 5, there are shown examples of audio resource collection pipelines 160, including real audio resource collection pipelines 162 and deepfake audio resource collection pipelines 164. The real audio resource collection pipelines 162 each result in a subject audio resource that is real and legitimate, and the deepfake audio resource collection pipelines 164 each result in a subject audio resource that is a deepfake or otherwise illegitimate. For each of the pipelines 160, a (human) speaker 158a-e is shown as speaking so as to produce audio waves embodying speech spoken by the speaker 158a-e. Although different numerals are used, it will be appreciated that the speaker 158a-e for each pipeline may be the same or different person.

As used herein, the term “direct,” when used in connection with an audio resource representing speech, refers to a version of the audio resource in which the underlying audio data is representative of initially-captured speech. As used herein, the term “indirect,” when used in connection with an audio resource representing speech, refers to a version of the audio resource in which the underlying audio data is representative of recaptured speech. As used herein, the term “recaptured,” when used in connection with an audio resource representing speech, refers to a version of the audio resource resulting from audio playback of the speech by an electronic audio speaker and capturing the audio playback. This capturing of the audio playback is a recapturing of the speech whereby such recaptured speech is represented as recaptured audio data. And, as used herein, the term “once-captured,” when used in connection with an audio resource representing speech, refers to a version of the audio resource resulting from a single capture of the speech and only a single capture of the speech, meaning that this version of the audio resource has been or is derived from a single or sole capture of the speech as it is spoken by its speaker. Accordingly, a recaptured audio resource cannot be a once-captured audio resource, although a once-captured audio resource may be used as a basis or starting point for generating a recaptured audio resource.

The real audio resource collection pipelines 162 includes a direct real audio resource collection pipeline 166 and an indirect real audio resource collection pipeline 168. In the direct real audio resource collection pipeline 166, speech is spoken by the speaker 158a and captured by a microphone 170a, capturing the speech as data embodying an audio resource. Each microphone 170a-d is considered an ultimate microphone or capture device as it is the last device for capturing speech (or audio playback of speech) prior to being introduced into the deepfake detection framework 100. Thus, for a given subject audio resource derived from capturing speech (or audio playback of speech), one of the microphone(s) 170a-d performs the last or ultimate capture of the speech in order to generate a subject audio resource that is usable for input into the deepfake detection framework 100. Each microphone 170a-d of a given one of the pipelines 160 may be the same or different microphone and, accordingly, these one or more microphones 170a-d are referred to as microphone(s) 170. That is, although four individual microphone icons are shown for the microphone(s) 170a-d, less than four different microphones may actually be used; for example, in one embodiment, each and all of the microphone(s) 170a-d is the same microphone meaning that the microphone(s) 170a-d represent a single microphone in practice, according to the present embodiment; as another example, at least one microphone 170a-d is different from another one of the microphone(s) 170a-d such that, in the present embodiment, two or three microphones in practice constitute the microphone(s) 170a-d, according to the present embodiment.

In the indirect or recaptured real audio resource collection pipeline 168, speech is spoken by the speaker 158b and captured by an initial capture device 178, which is depicted as a smartphone or handheld mobile device in FIG. 5. The initially-captured audio resource is then used for generating audio playback of the speech, and this audio playback of the recorded speech is then captured by the microphone 170b. In embodiments, the initially-captured audio resource may be uploaded or YouTube™ as a part of audiovisual media (e.g., video with sound), SoundCloud™ for audio playback, or other website or data storage. The initially-captured resource may then be transmitted to any of a number of devices, including communicating said audio via Bluetooth™ or Bluetooth™ Low Energy (BLE) to an electronic audio speaker 180 for audio playback of the initially-captured resource, as shown in FIG. 5. In the indirect or recaptured real audio resource collection pipeline 168, the version of the audio resource captured by the microphone 170b is referred to a recaptured audio resource as speech represented by the recaptured audio resource is derived from audio playback of initially-captured speech and, more particularly, because it is a real or bonafide audio resource, it is referred to as a real or bonafide recaptured audio resource.

The deepfake audio resource collection pipelines 164 include three different deepfake speech audio generation pipelines 172-176, each used for generating a deepfake audio resource having fake or illegitimate speech. A recaptured deepfake audio resource is generated as a result of each of a first recaptured deepfake audio resource pipeline 172 and a second recaptured deepfake audio resource pipeline 174. The recaptured deepfake audio resource is derived from the deepfake audio generator 138, which uses the deepfake generation model 140 in order to generate deepfake audio resources for a given speaker. The deepfake generation model 140 is trained using bonafide audio resources having speech of the given speaker, and is then usable for generating deepfake audio resources. While the deepfake audio generator 138 and the deepfake generation model 140 are shown in FIG. 5 and described in regards thereto, in operation of the deepfake detection framework 100 after having been trained or otherwise configured for deepfake detection, would be used for detecting whether new, unseen audio resources are deepfakes or bonafide. Accordingly, such deepfake subject audio resources input into the deepfake detection trained ML network pipeline 106 for deepfake detection are generated (or likely generated) by a different (and potentially nefarious) deepfake generator that may be configured and/or operated by a nefarious individual (referred to herein as a “deceiver”).

Each of the first and second recaptured deepfake audio resource pipelines 172,174 includes generating a deepfake audio resource having speech, causing audio playback of the deepfake audio resource, and capturing the audio playback (using the microphone(s) 170c-d) as a recaptured deepfake audio resource. In embodiments, the recaptured deepfake audio resource is an enhanced or laundered deepfake audio resource. As used herein, the term “enhanced,” when used in connection with a deepfake audio resource, refers to performing post-processing on the deepfake audio resource in order to generate a modified version of the deepfake audio resource through introduction of audio deepfake laundering or anti-forensic-processing technique(s), such as those performed by the audio launderer 144. The second recaptured deepfake audio resource pipeline 174 is a recaptured enhanced deepfake audio resource as audio playback of enhanced deepfake audio is output by an electronic audio speaker is recaptured.

An uncaptured deepfake audio pipeline 176 is used for generating a deepfake audio resource that is not captured by a microphone or other sound/audio recording device, which is referred to as an uncaptured deepfake audio resource. The uncaptured deepfake audio resource may be input into the deepfake detection trained ML pipeline 106 in order to generate a deepfake audio indicator. The deepfake audio indicator here would indicate that the input subject audio resource is a deepfake and, in embodiments, indicates a deepfake characteristic, such as a deepfake classification.

As used herein, a “deepfake characteristic,” when used in connection with an audio resource, refers to a classification, value, or other indicator that indicates the audio resource embodies one or more aspects of deepfake audio (such aspects are referred to each as a deepfake audio aspect). A deepfake characteristic for an audio resource indicates one or more deepfake audio aspects are present within and/or embodied by the audio resource. In one embodiment, a plurality of deepfake types is defined, wherein each deepfake type is defined by one or more deepfake characteristic criteria whereby an audio resource is deemed to be of the deepfake type when the audio resource has deepfake characteristic(s) meeting predefined deepfake characteristic(s) defined in advance for this deepfake type.

In one embodiment, a plurality of deepfake characteristics is determined, including a deepfake injection indicator, a deepfake impersonation indicator, and a replay impersonation indicator. As used herein, a deepfake injection indicator, when used in connection with an audio resource, refers to an indicator that indicates the audio resource has been generated using a deepfake generator. As used herein, a deepfake impersonation indicator, when used in connection with an audio resource, refers to an indicator that indicates the audio resource is a recaptured deepfake audio resource. As used herein, a replay impersonation type, when used in connection with an audio resource having speech, refers to an indicator that indicates the speech had been output as audio playback and captured as a recaptured audio resource constituting the audio resource.

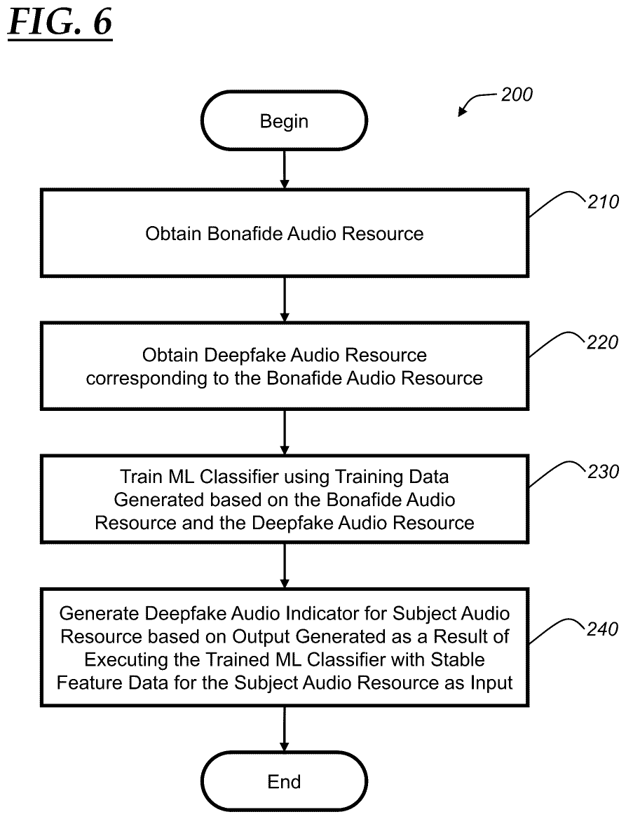

With reference to FIG. 6, there is shown a method 200 of detecting a deepfake audio resource. The method 200 is performed by the deepfake audio detection system 12, at least in embodiments. Although the steps 210-240 are illustrated and described as being performed in a particular order, those skilled in the art will appreciate that the steps may be performed according to any technically-feasible order, such as where step 230 is performed concurrently with or prior to step 220, for example.

The method 200 is described as being performed for detecting deepfakes for a particular speaker and, accordingly, is used for performing speaker-specific deepfake audio detection, which refers to detecting whether a subject audio resource having audio of speech of the speaker is legitimate or not, such as where the subject audio resource is a deepfake, using a deepfake detection model that is specifically tailored to the speaker. Moreover, in the present embodiment, the speaker-specific deepfake detection is performed by the deepfake detection ML network pipeline 102 whereby a deepfake detection ML network is specifically trained for a particular individual (referred to as a “speaker”), and then used for determining whether unseen audio resources are legitimate or not. The speaker for which the method 200 below is performed is referred to as the “subject speaker.” After the speaker-specific ML model is trained (using steps 210-230), the trained speaker-specific ML model is used for determining whether an audio resource is fake or illegitimate or not, and this audio resource is referred to as the “subject audio resource.”

The method 200 begins with step 210, wherein a bonafide audio resource is obtained. The bonafide audio resource includes speech of the subject speaker. The bonafide audio resource is obtained from one of the real audio resource collection pipelines 162, according to one embodiment. The method 200 continues to step 220.

In step 220, a deepfake version of the bonafide audio resource is obtained and this obtained deepfake version is referred to as a deepfake audio resource and is considered to “correspond to” the bonafide audio resource. The deepfake audio resource is generated using the deepfake generation pipeline 126 and, in some embodiments, also using the deepfake laundering pipeline 128. Both the bonafide audio resource and the deepfake audio resource are stored in a data store, such as the training data store 142, at least in embodiments. This data may, thus, in such embodiments, be used as training data.

In one embodiment, the training data is obtained from a third party, such as from the third party server 18 and/or the third party device 20. In some embodiments, the training data is generated, at least in part, by the deepfake detection ML network training pipeline 104. For example, in embodiments, the speaker-specific deepfake generation pipeline 126 is used for generating deepfake versions of bonafide audio resources and, in the present embodiment, these deepfake versions are used as a part of the negative-classification training data. The training data is obtained using the speaker data collection pipeline 124, at least in one embodiment. The method 200 continues to step 230.

Conventional deepfake detection systems are typically implemented as large, speaker-independent binary classifiers trained on both bonafide and synthetic speech samples. Such systems frequently rely on residual artifacts introduced by particular text-to-speech (TTS) or voice conversion pipelines. Because these artifact-dependent classifiers learn decision boundaries tied to specific generative systems, microphones, codecs, or recording conditions present in their training data, they often exhibit degraded performance when exposed to previously unseen generative models, new capture devices, alternative codecs, or real-world background conditions. This artifact-centric paradigm limits generalization and creates susceptibility to evolving generative technologies designed to minimize detectable artifacts.

In contrast, embodiments of the present method and system implement a speaker-specific one-class modeling framework that learns only the distribution of bonafide speech associated with a subject speaker and constructs a boundary around that distribution in a stability-qualified feature or embedding space. Rather than relying on artifacts characteristic of particular synthetic generation pipelines, according to embodiments, the method and system model stable, speaker-specific characteristics extracted from bonafide speech. Accordingly, in such embodiments, any subject audio resource whose representation falls outside the learned boundary—including synthetic speech purporting to be from the subject speaker, speech from other speakers, or otherwise anomalous samples—is flagged as illegitimate. This approach reduces dependence on known deepfake artifacts and improves generalization to unseen generative systems and channel conditions, at least according to embodiments.

In step 230, a deepfake detection classifier network is trained using training data generated based on the bonafide audio resource obtained in step 210 and the deepfake audio resource corresponding to the bonafide audio resource obtained in step 220. In one embodiment, the deepfake detection classifier network 116 is trained using this training data, including training the single-class ML model 118 and/or the multi-class ML model 120. According to one embodiment, the single-class ML model is trained using only the positive-classification training data, which means that the negative-classification training data (which is used for training the multi-class ML model) is not used for training the single-class ML model. However, in other embodiments, the single-class ML model may be trained using negative-classification training data in addition to or in lieu of the positive-classification data.

The single-class ML model is a one-class support vector machine (SVM) that is trained using the positive-classification data only and configured to generate a binary indication of whether a given input is an inlier (or normal) and assigned a positive class (e.g., corresponding to a value of one (1)) or is an outlier (or an anomaly) and assigned a negative class (e.g., corresponding to a value of zero (0) or negative one (−1)). In one embodiment, the positive-classification training data, which consists only of inputs corresponding to the positive class, meaning those inputs are inliers. A training: test split of 70:30 may be used for the training data, as discussed above. In some embodiments, a training data set of at least one thousand (1000) audio samples of each having audio of no more than twenty seconds is used for training the one-class SVM. In another embodiment, a smaller number of audio samples with more aggressive learning may be performed, although this may be more prone to false negatives as it will have an inlier bound not encompassing unseen legitimate audio samples, potentially, depending on the nature and number of the positive-classification training data. The ML network trainer 24 is used for obtaining a base SVM model, obtaining the positive-classification training data (step 210), and then training the base SVM model using a decision boundary learning process for learning an inlier or normal boundary for the given training data used for training, which would be real or legitimate speech features extracted via the feature extractor 114 from real audio samplings or resources.

In embodiments, the one-class ML model defines a decision boundary around the unified bonafide cluster within the stability-qualified embedding space. The boundary may be defined using a one-class support vector machine, support vector data description (SVDD), hypersphere-based learning, density estimation, or other one-class boundary estimation techniques. Because the boundary is constructed using bonafide speech only, synthetic samples are not required during training in order to achieve separation in the learned space.

To enable robust one-class detection, the feature extractor 114 may incorporate multiple representation families whose outputs are unified within a common embedding or feature space prior to boundary estimation. Such representation families may include self-supervised speech embeddings derived from pretrained speech encoders, speaker-discriminative embeddings configured to emphasize speaker identity characteristics, and stability-qualified handcrafted acoustic features including prosody, articulation, and phonation descriptors. In embodiments, these representations are concatenated, projected, or otherwise fused at a representation level to form a composite stability-aware embedding that serves as input to the one-class ML model.

Although certain embodiments describe the ML classifier as including a one-class ML model (e.g., a one-class support vector machine (SVM), a one-class Gaussian mixture model (GMM), or a combination thereof), the trained ML classifier may comprise any suitable supervised, semi-supervised, or unsupervised learning model configured to consume the stable feature vector and generate a deepfake audio indicator. By way of example and without limitation, the ML classifier may include one or more of: support vector machines (including one-class or binary SVMs), logistic regression models, random forest classifiers, gradient-boosted decision trees, k-nearest neighbor classifiers, shallow neural networks, multilayer perceptrons, density estimation models, hypersphere learning models, or other statistical or machine learning architectures. In embodiments, the classifier architecture is selected independently of the stability-oriented feature extractor, such that the novelty resides in the stable feature construction and representation rather than any specific classifier type.

In embodiments, the ML classifier may generate multiple output modes corresponding to different detection objectives. For example, the deepfake audio indicator may include any one or more of the following: (i) a binary indicator identifying a subject audio resource as legitimate or illegitimate; (ii) a multi-class indicator identifying a category or type of deepfake or spoofing method; (iii) a confidence score representing a likelihood, probability, margin distance, or anomaly score associated with the classification decision; and/or (iv) a reason code derived from one or more anomalous feature values or feature groups contributing to the classification outcome. The reason code may identify, for example, specific prosody, articulation, phonation, statistical, or embedding-derived features whose values deviate from a learned bonafide distribution beyond a defined threshold.

In embodiments, the system and method are configured to learn or construct an embedding space in which bonafide speech of the subject speaker—across variations in microphone type, codec, room acoustics, emotional state, and speaking style—is mapped into a single compact cluster. Synthetic speech samples purporting to correspond to the same speaker are encouraged to lie outside this cluster. In some embodiments, domain-aligned embedding learning is employed, wherein bonafide samples collected from different recording environments are explicitly encouraged, through regularization or metric learning objectives, to collapse into a unified representation. Stability-regularized training may further be applied using transformation pairs, such that embeddings derived from original and transformed versions of the same bonafide utterance remain proximate in the embedding space.

Also, in embodiments, a multi-class ML model is trained using both the bonafide audio resource and the deepfake version of the bonafide audio resource, where the bonafide audio resource is a part of the positive-classification training data and the deepfake audio resource corresponding to the bonafide audio resource is a part of the negative-classification training data. The multi-class ML model is a Gaussian mixture model (GMM) trained for identifying a subject audio resource as being illegitimate or legitimate and, in at least some embodiment, a type of deepfake or otherwise classed into one of a plurality of negative classes. The ML network trainer 24 is used for obtaining a base GMM, obtaining the training data (steps 210-220), and then training the multi-class ML model using an expectation-maximization (EM) algorithm. In embodiments, two classes may be used for the GMM, but where each class includes multiple components, enabling sub-class classifications; however, in other embodiments, the GMM is configured with three or more classes, each with one or more components. A training: test split of 70:30 may be used for the training data, as discussed above. Although multi-class modeling may be employed in certain embodiments, the speaker-specific one-class modeling framework described herein enables detection without reliance on synthetic training samples or artifact-specific cues, thereby enhancing robustness to unseen generative systems.

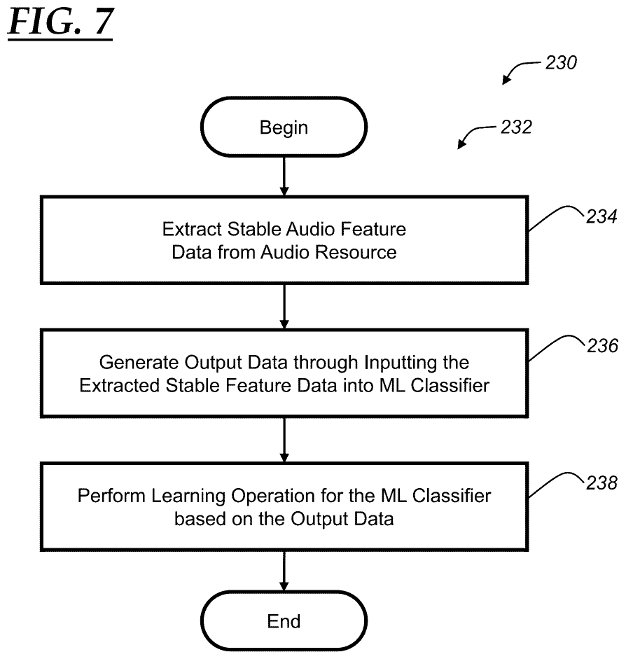

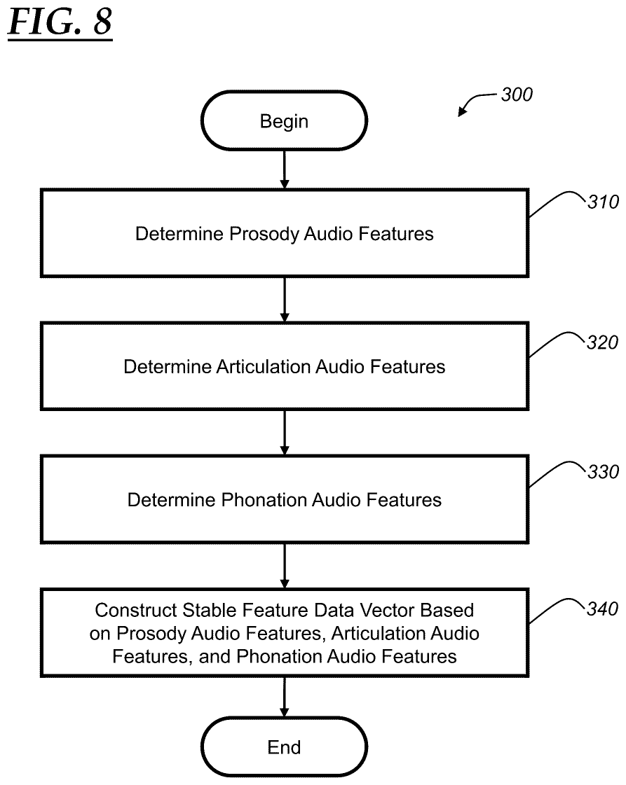

With reference to FIG. 7, there is shown an embodiment of a training process 232 for training a deepfake detection classifier network, such as the deepfake detection classifier network 116, whereby the training process 232 performs the step 230, according to at least one embodiment. The training process 232 begins with step 234 in which stable audio feature data is extracted from audio resources. The audio feature data is extracted using the feature extractor 114 and, in embodiments, the process 300 (FIG. 8, below) is performed in order to generate a stable feature data vector as the audio feature data. The process 232 continues to step 326.

In step 236, output data is generated through inputting the extracted audio feature data into the deepfake detection classifier network, such as the deepfake detection classifier network 116. The deepfake detection classifier network is trained to classify a subject audio resource as bonafide or a deepfake (illegitimate) and, in embodiments, may also indicate a deepfake type. The process 232 continues to 238.

In step 238, a learning operation is performed for the deepfake detection classifier network based on the output data. The output data indicates or includes the deepfake audio indicator for the subject audio resource, and is used to perform learning for the deepfake detection classifier network 116, such as through performing learning operations for the single-class ML model 118 and the multi-class ML model 120, as discussed above. The learning operation includes, in one embodiment, adjusting one or more weights or parameters of a ML model constituting the deepfake detection classifier network 116 such as through, for example, supervised-learning backpropagation techniques.

A first training iteration of the process 232 ends after step 238, but one or more, generally a plurality, of other training iterations are performed, such as where a different bonafide audio resource and corresponding deepfake audio resource are used. The trained deepfake detection classifier network is then stored in the ML model repository 28, at least in embodiments.

With reference back to FIG. 6, the method 200 continues to step 240 after the deepfake detection classifier network is trained in step 230. In step 240, a deepfake audio indicator is generated for a subject audio resource that is unseen, meaning the subject audio resource has not been input into the deepfake detection classifier network 116 that is, as a part of the present step, used for generating the deepfake audio indicator based on using the subject audio resource (or its feature data as extracted from the feature extractor 114, for example) as input.

In embodiments, the deepfake audio indicator is based on a single-class output and a multi-class output. In one embodiment, the subject audio resource is received at the deepfake ML network pipeline 102 and, specifically, the deepfake detection trained ML network pipeline 106 whereby the subject audio resource may be pre-processed using the ML network input processor 148 and then input into the deepfake detection trained ML network 112. In particular, a subject audio resource ML input is generated from the subject audio resource at the ML network input processor 148 so that audio from the subject audio resource input into the deepfake detection trained ML network 112 is formatted, normalized, standardized, tokenized, encoded, string or byte padded, and/or otherwise packaged, prepared, and/or processed in order to be in a suitable form for use by the deepfake detection ML network 112 used for determining the deepfake audio indicator.

The subject audio resource is used as input into the feature extractor 114, such as by inputting the subject audio resource ML input into the feature extractor 114. A process 300 for extracting audio features from a subject audio resource is described below with reference to FIG. 8, and this process 300 may be used as a part of the present step for purposes of generating feature data used for input into the deepfake detection classifier network 116. For example, the extracted audio features are then input into both the single-class ML model 118 and the multi-class ML model 120. Using the extracted audio features, the single-class ML model 118 generates a single-class ML model output, which is a binary indicator indicating whether the subject audio resource is legitimate or not. Also, using the extracted audio features, the multi-class ML model 120 generates a multi-class ML model output, which is an indicator indicating whether the subject audio resource is legitimate or not, and may indicate sub-classifications thereof, such as a probable or predicted type of deepfake or laundering attack is used on the subject audio resource. The single-class ML model output and the multi-class ML model output are then used as input into the ML network output resolver 122, which then makes a final determination as to whether the subject audio resource is a deepfake or otherwise illegitimate or not, which is then represented as the deepfake audio indicator. The deepfake audio indicator is stored in memory and/or provided to a user, such as a user using the third party server 18 and/or the third party device 20.

In embodiments, the step 240 of the method 200 is performed once for each of a plurality of subject audio resources so as to generate a plurality of deepfake audio indicators, which may then be stored in a data store (e.g., the ML network output data store 150) and/or may be sent or otherwise provided to the third party server 18, the third party device 20, or other device, server, or system via the interconnected data communications network 22, for example. The method 200 ends.

With reference to FIG. 8, there is shown a stable audio feature extraction process 300 for a subject audio resource, according to an embodiment. Although the steps of the process 300 are shown and described as being performed in a particular order, it will be appreciated that the steps of the process 300 are performable in any technically-feasible manner, as will be made apparent to those skilled in the art in light of the discussion herein. For example, steps 320 and/or 330 may be performed prior to or concurrently with step 310, according to an embodiment. The stable audio feature extraction process 300 is performed for separately for the bonafide audio resource and then for the corresponding deepfake audio version. As used herein, the term “corresponding deepfake audio resource,” when used in connection with a connection with a bonafide audio resource, refers to a deepfake version of the bonafide audio resource.

The process 300 begins with step 310, wherein prosody audio features are obtained. In step 320, articulation audio features are obtained and, in step 330, phonation audio features are obtained. These audio features are obtained through calculating audio feature value(s) for each audio feature through performing audio processing techniques on the subject audio resource. The extracted or obtained feature values are stored in memory, and used as input into the deepfake detection classifier network 116.

According to embodiments, the audio features are determined using any of a number of techniques. In one embodiment, for example, one or more (or all) of the audio features are determined by mathematically performing closed-form calculations in order to obtain a definite audio feature value. In embodiments, a ML model is not used for the feature extractor 114; rather, in such embodiments, for example, rather than a data-driven or ML model, the feature extractor 114 is comprised of a plurality of software modules implementing closed-form calculations so as to always result in the same output, provided the same input, which is not the case with data driven models.

In other embodiments, a data-driven ML model is used and, in at least some of such embodiments, the data-driven or ML model is used in combination with the closed-form (or non-data-driven) calculations; for example, a ML model interposed between an output of the closed-form calculator of the feature extractor 114 and an input to the deepfake detection classifier network 116 whereby outputs from the closed-form calculator are combined with parameter values of the interposed ML model in order to apply various weighting and/or otherwise adapting the output of the closed-form calculator. In embodiments, this interposed ML model may also take, as input, the subject audio resource or other data pertaining thereto that was not generated or output by the feature extractor 114. Such embodiments allow the calculated feature values to be adapted (slightly, or to an extent adjustable via training method and hyperparameters) in a learned manner while still retaining a bulk of the underlying audio feature calculation data. After the audio feature values are obtained, the process 300 continues to step 340.

In step 340, a stable feature data vector is generated based on the prosody audio features, the articulation audio features, and the phonation audio features. The stable feature data vector is defined according to an input of the deepfake detection classifier network 116, such as where, for example, said vector's size and dimensionality is predefined. In embodiments, the stable feature data vector includes a multitude (i.e., thirty-six (36)) of audio features and, in one embodiment, includes a multitude of prosody audio features, a multitude of articulation audio features, and/or a multitude of phonation audio features. The stable feature data vector is used as a part of the training process and/or part of inference or live/real/in-operation deepfake detection of unseen subject audio resources. The process 300 ends.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of detecting a deepfake audio resource, comprising the steps of:
obtaining bonafide audio resource and a deepfake audio resource;
generating bonafide audio feature data based on the bonafide audio resource;
generating deepfake audio feature data based on the deepfake audio resource;
training a machine learning (ML) classifier using the bonafide audio feature data and the deepfake audio feature data; and
generating a deepfake audio indicator for a subject audio resource based on an output generated by inputting the subject audio resource into the trained ML classifier.

2. The method of claim 1, wherein the bonafide audio feature data and the deepfake audio feature data each includes one or more feature values for each of a plurality of predetermined audio features.

3. The method of claim 1, wherein generating the deepfake audio indicator includes generating a binary classification indicator identifying the subject audio resource as legitimate or illegitimate.

4. The method of claim 1, wherein generating the deepfake audio indicator includes generating a multi-class indicator identifying a type of deepfake or spoofing technique.

5. The method of claim 1, wherein generating the deepfake audio indicator includes generating a confidence score corresponding to a likelihood or anomaly measure associated with the subject audio resource.

6. The method of claim 1, wherein generating the deepfake audio indicator includes generating a reason code identifying one or more predetermined audio features whose feature values deviate from a learned bonafide distribution beyond a threshold.

7. The method of claim 6, wherein the reason code identifies at least one of: a prosody audio feature, an articulation audio feature, a phonation audio feature, or an embedding-derived feature.

8. The method of claim 1, wherein the deepfake audio resource corresponds to the bonafide audio resource whereby the deepfake audio resource is a deepfake version of the bonafide audio resource.

9. The method of claim 8, wherein the bonafide audio resource includes speech from a speaker, wherein the deepfake audio resource includes a deepfake version of the speech, and wherein the ML classifier is a speaker-specific ML classifier.

10. The method of claim 8, wherein training the ML classifier includes: generating bonafide audio features and deepfake audio features, and wherein the bonafide audio features and the deepfake audio features each includes one or more feature values for each of a plurality of predetermined audio features.

11. The method of claim 8, wherein the deepfake audio indicator is generated by:
generating audio feature data for the subject audio resource, and generating the deepfake audio indicator as a result of classifying the subject audio resource using the audio feature data as input into the trained ML classifier.

12. The method of claim 11, wherein the audio feature data is determined for a plurality of predetermined audio features, and wherein feature values for the plurality of predetermined audio features are included in the audio feature data and are determined using closed-form calculations.

13. A method of training a deepfake detection classifier network, comprising the steps of:
obtaining a bonafide audio resource;
obtaining a deepfake audio resource;
determining bonafide audio feature data based on the bonafide audio resource, wherein the bonafide audio feature data includes one or more feature values for each of a plurality of predetermined audio features;
determining deepfake audio feature data based on the deepfake audio resource, wherein the deepfake audio feature data includes one or more feature values for each of the plurality of predetermined audio features;
performing a first learning operation for a machine learning (ML) classifier using the bonafide audio feature data; and
performing a second learning operation for the ML classifier using the deepfake audio resource.

14. The method of claim 13, wherein the plurality of predetermined audio features includes at least one prosody audio feature, at least one articulation audio feature, and at least one phonation audio feature.

15. The method of claim 13, wherein the ML classifier includes multiple ML models.

16. The method of claim 15, wherein the multiple ML models include a single-class ML model and a multi-class ML model.

17. The method of claim 13, wherein the bonafide audio feature data and the deepfake audio feature data each includes one or more feature values for each of a plurality of predetermined audio features.

18. The method of claim 17, wherein the plurality of predetermined audio features includes at least one prosody audio feature, at least one articulation audio feature, and at least one phonation audio feature.

19. The method of claim 13, wherein the ML classifier comprises at least one of: (i) a support vector machine; (ii) a logistic regression model; (iii) a random forest classifier; (iv) a gradient-boosted decision tree model; (v) a k-nearest neighbor classifier; (vi) a neural network; (vii) a multilayer perceptron; (viii) a density estimation model; and/or (ix) a hypersphere learning model.

20. The method of claim 13, wherein the ML classifier comprises a one-class classifier configured to learn a distribution of bonafide speech and to identify as illegitimate any subject audio resource falling outside a learned boundary.

21. The method of claim 20, wherein the learned boundary is defined using at least one of: (i) a one-class support vector machine; (ii) support vector data description (SVDD); (iii) hypersphere learning, density estimation; (iv) Gaussian mixture modeling; and/or (v) kernel-based anomaly detection.

22. A method of detecting a deepfake audio resource, comprising the steps of:
determining stable audio feature data for a subject audio resource, wherein the stable audio feature data includes feature values for a plurality of predetermined audio features configured to remain invariant under predefined audio transformations;
inputting the stable audio feature data into a trained one-class classifier configured to model a distribution of bonafide speech of a subject speaker; and
generating a deepfake audio indicator when the stable audio feature data falls outside a learned boundary of the distribution.

23. The method of claim 22, wherein the learned boundary is defined using at least one of: (i) a one-class support vector machine; (ii) support vector data description (SVDD); (iii) hypersphere learning, density estimation; (iv) Gaussian mixture modeling; and/or (v) kernel-based anomaly detection.

24. The method of claim 22, wherein the distribution of bonafide speech of the target speaker is determined based only on bonafide speech samples of the target speaker and excludes synthetic or deepfake speech samples during training of the one-class classifier.

25. The method of claim 22, wherein the distribution of bonafide speech of the target speaker is defined in a stability-qualified feature space such that bonafide speech samples of the target speaker, including samples captured under varying microphones, codecs, acoustic environments, and processing conditions, are mapped within a compact region bounded by the learned boundary.
